(19) United States
(12) Patent Application Publication
(10) Pub. No.: US 2003/0071919 A1
(43) Pub. Date: Apr. 17, 2003

(54) Display characterization using heterochromatic photometry

(75) Inventor: Gustav Braun, Fairport, NY (US)

Correspondence Address: Thomas H. Close,, Patent Legal Staff, Eastman Kodak Company, 343 State Street, Rochester, NY, 14650-2201, US

(73) Assignee: Eastman Kodak Company

(21) Appl. No.: 09/925,996

(22) Filed: Aug. 9, 2001

(51) Int. Cl. H04N 5/217

(52) U.S. Cl. 348/618; 348/910

(57) ABSTRACT

A method of characterizing a display having a plurality of color channels, that includes the steps of: visually characterizing the gamma of the display; estimating a colorimetric mixing matrix for the display by determining luminance ratios of the color channels using heterochromatic photometry; and combining these luminance ratios with a chromaticity model for the display channels.

### FIELD OF THE INVENTION

This invention relates to the visual characterization of a display and more particularly of a display without the use of characterization hardware.

### BACKGROUND OF THE INVENTION

U.S. Pat. No. 5,754,222 issued May, 1998 to Daly et al. discloses a method for visually calibrating a display by performing a visual offset estimation; determining a display gamma using a spatially modulated target; and determining an additive calorimetric mixing matrix using a neutral identification process. The step of determining the colorimetric mixing matrix relies on the visual identification of a neutral. Another approach to characterizing a display is shown in U.S. Pat. No. 6,023,264 issued Feb. 8, 2000 to Gentile et al. who employ a different stimulus presentation technique from that of Daly et al., but the step of determining a calorimetric mixing matrix also relies on the visual identification of neutral. Since these prior art processes rely on subjective viewer input, they are subject to viewer variability and interpretation, thereby limiting the repeatability and accuracy of the characterization. Another approach to characterizing a display is shown in U.S. Pat. No. 5,638,117 issued Jun. 10, 1997 to Engeldrum et al. where a display patch is adjusted to match a reference card of known colorimetry. This process is very difficult to perform because it requires the viewer to make both luminance and hue adjustment which may or may not be familiar to the viewer.

There is a need therefore for an improved method of visually characterizing a display that provides a more objective method of determining the colorimetric mixing matrix.

### SUMMARY OF THE INVENTION

The need is met according to the present invention by providing a method of characterizing a display having a plurality of color channels, that includes the steps of: visually characterizing the gamma of the display; and estimating a colorimetric mixing matrix for the display by determining luminance ratios of the color channels using heterochromatic photometry. As used herein, heterochromatic photometry means either brightness matching photometry or minimum flicker photometry.

### ADVANTAGES

The present invention has the advantage that the method of determining the calorimetric mixing matrix is more objective than methods employed in the prior art, thereby resulting in more repeatable and accurate characterization of the display.

### BRIEF DESCRIPTION OF THE DRAWINGS

FIG. 1 is a diagram useful in explaining the prior art method of heterochromatic brightness matching;

FIG. 2 is a diagram useful in explaining the prior art method of heterochromatic flicker photometry;

FIG. 3 is a timing and intensity diagram useful in describing the prior art method of flicker photometry;

FIG. 4 is a timing and intensity diagram useful in describing the prior art method of flicker photometry;

FIG. 5 is a diagram useful in describing the perception of flicker in heterochromatic photometry experiments; and

FIG. 6 is a flow chart illustrating the method of the present invention.

### DETAILED DESCRIPTION OF THE INVENTION

This invention provides the means to determine the calorimetric mixing matrix of an additive color display device such as a cathode-ray tube (CRT) using a series of visual photometric assessments. It is known that a three-channel display device that exhibits additive color mixing properties can be modeled using a 3-by-3 rotation matrix that converts gamma-corrected digital count values to calorimetric quantities such as CIE tristimulus values. See Berns, R. S., Motta, R. J., and Gorzynski, M. E. “CRT Colorimetry. Part 1: Theory and Practice”, Color Research and Application, Vol. 18, No. 5, pp. 299-314, 1993.

The form of this matrix depends on two factors. The first factor is the spectral power distribution of the display's phosphors (which determines the chromaticities of the phosphors). The second factor is the luminance ratios of the display's channels (i.e., the white point of the display). The present invention provides an all-visual process designed to determine the ratios of the channel luminances. Based on these channel-luminance ratios and an estimate of the display phosphor chromaticities, an estimate of the colorimetric mixing properties of a display is generated. This colorimetric mixing matrix can be used, in conjunction with an estimate of the display's channel nonlinearities (e.g., the gammas of the display channels), to generate an ICC profile, or some other characterization, of the display's calorimetric properties. The estimate of the display channel nonlinearities can be performed using the technique shown by Daly et al. (supra).

Estimation of a display's channel nonlinearities using the process disclosed by Daly et al. (supra) consists of visually estimating the parameters in a CRT model. These terms are an offset and gamma value. The offset term is estimated by having the viewer select the first visible stimulus from a code value ramp. The device code values associated with this first visible patch represents the offset of the model. The gamma parameter of their model is determined using a target that has a spatially modulated field and a continuous tone field. A series of these targets is generated for assumed values of gamma using the visually estimated offset. The target whose brightness of the spatially modulated field most closely matches the brightness of the continuous tone field corresponds to the correct gamma for the display. One strong feature of their process is in the form of their visual target. The boundary line between the continuous tone field and the spatially modulated field is on an angle. This makes the visual task of matching the two fields much easier than if the interface between the field were oriented vertically or horizontally, due to the frequency response of the human visual system.

The present invention uses heterochromatic-flicker photometry or heterochromatic-brightness matching photometry, to obtain the display channel luminance ratios contained in the colorimetric mixing matrix. For a three-channel, additive display device such as a cathode-ray tube (CRT) or a liquid-crystal display (LCD), the CIE tristimulus values (XYZ) of mixtures of the three primaries are obtained by summing the XYZ values contributed by the red, green, and blue channels. This relationship can be formalized by:

$${[ \begin{matrix}X \\ Y \\ Z\end{matrix} ]}_{mixture} = \underbrace{[ \begin{matrix}{X}_{red} & {X}_{green} & {X}_{blue} \\ {Y}_{red} & {Y}_{green} & {Y}_{blue} \\ {Z}_{red} & {Z}_{green} & {Z}_{blue}\end{matrix} ]}_{M} \cdot [ \begin{matrix}r \\ g \\ b\end{matrix} ] \qquad ( 1 )$$

where XYZₘᵢₓₜᵤᵣₑ is the tristimulus value of the mixture of r amount of the red primary, g amount of the green primary, and b amount of the blue primary. The columns in the 3×3 matrix (M) shown in Eq. 1 represent the maximum XYZ tristimulus values of the red, green, and blue primaries. Thus, the range on the rgb scalars is between 0 and 1. Modulating the values of the rgb scalars generates the range of mixture colors.

The white point of the system is commonly defined for the point when the rgb scalars are set to their full values (i.e., r=g=b=1). Therefore, the calorimetric value of the white point is given by:

$${[ \begin{matrix}X \\ Y \\ Z\end{matrix} ]}_{white} = [ \begin{matrix}{X}_{red} & {X}_{green} & {X}_{blue} \\ {Y}_{red} & {Y}_{green} & {Y}_{blue} \\ {Z}_{red} & {Z}_{green} & {Z}_{blue}\end{matrix} ] \cdot [ \begin{matrix}1 \\ 1 \\ 1\end{matrix} ] \qquad ( 2 )$$

The chromaticities of a set of CIE tristimulus values is given by:

$$x = \frac{X}{X + Y + Z} , y = \frac{Y}{X + Y + Z} , \text{and} z = \frac{Z}{X + Y + Z} . \qquad ( 3 )$$

Therefore, it is possible to reconstruct the CIE XYZ values from ratios of the chromaticities and the luminance of the color by:

$$X = Y \cdot \frac{\frac{X}{X + Y + Z}}{\frac{Y}{X + Y + Z}} = Y \cdot \frac{x}{y} \text{and similarly} Z = Y \cdot \frac{z}{y} \qquad ( 4 )$$

For a system with fixed primaries, changing the ratios of the luminances of the red, green, and blue channels changes the white point of the system. For example, it is possible to rewrite the primaries matrix shown in Eq. 1 to have the form:

$$M = C \cdot L = \underbrace{[ \begin{matrix}\frac{{x}_{red}}{{y}_{red}} & \frac{{x}_{green}}{{y}_{green}} & \frac{{x}_{blue}}{{y}_{blue}} \\ 1 & 1 & 1 \\ \frac{{z}_{red}}{{y}_{red}} & \frac{{z}_{green}}{{y}_{green}} & \frac{{z}_{blue}}{{y}_{blue}}\end{matrix} ]}_{C} \cdot \underbrace{[ \begin{matrix}{Y}_{red} & 0 & 0 \\ 0 & {Y}_{green} & 0 \\ 0 & 0 & {Y}_{blue}\end{matrix} ]}_{L} \qquad ( 5 )$$

where xyz_{red,green,blue} and Y_{red,green,blue} are the chromaticities and the luminances of the red, green, and blue primaries respectively. By varying the ratios of Y_{red,green,blue,} the form of the L matrix changes. This in turn changes the form of the M matrix used to convert from rgb scalars to XYZ. This has a subsequent effect on the chromaticities of the white. For a given C matrix, the chromaticities of the white point are invariant with the absolute levels of Y_{red}, Y_{green}, and Y_{blue} as long as the ratios of Y_{red}/Y_{green} and Y_{blue}/Y_{green} remain constant.

Thus, for a given white point and C matrix, it is possible to rewrite Eqs. 2 and 5 to solve for the channel luminances Y_{red}, Y_{green}, and Y_{blue} that produce the desired white point, as shown in Eqs. 6-8.

$$\begin{matrix}{[ \begin{matrix}X \\ Y \\ Z\end{matrix} ]}_{white} = [ \begin{matrix}\frac{{x}_{red}}{{y}_{red}} & \frac{{x}_{red}}{{y}_{red}} & \frac{{x}_{red}}{{y}_{red}} \\ 1 & 1 & 1 \\ \frac{{z}_{red}}{{y}_{red}} & \frac{{z}_{green}}{{y}_{green}} & \frac{{z}_{blue}}{{y}_{blue}}\end{matrix} ] \cdot [ \begin{matrix}{Y}_{red} & 0 & 0 \\ 0 & {Y}_{green} & 0 \\ 0 & 0 & {Y}_{blue}\end{matrix} ] \cdot [ \begin{matrix}1 \\ 1 \\ 1\end{matrix} ] & ( 6 ) \\ {[ \begin{matrix}X \\ Y \\ Z\end{matrix} ]}_{white} = [ \begin{matrix}\frac{{x}_{red}}{{y}_{red}} & \frac{{x}_{red}}{{y}_{red}} & \frac{{x}_{red}}{{y}_{red}} \\ 1 & 1 & 1 \\ \frac{{z}_{red}}{{y}_{red}} & \frac{{z}_{green}}{{y}_{green}} & \frac{{z}_{blue}}{{y}_{blue}}\end{matrix} ] \cdot [ \begin{matrix}{Y}_{red} \\ {Y}_{green} \\ {Y}_{blue}\end{matrix} ] & ( 7 ) \\ [ \begin{matrix}{Y}_{red} \\ {Y}_{green} \\ {Y}_{blue}\end{matrix} ] = {[ \begin{matrix}\frac{{x}_{red}}{{y}_{red}} & \frac{{x}_{red}}{{y}_{red}} & \frac{{x}_{red}}{{y}_{red}} \\ 1 & 1 & 1 \\ \frac{{z}_{red}}{{y}_{red}} & \frac{{z}_{green}}{{y}_{green}} & \frac{{z}_{blue}}{{y}_{blue}}\end{matrix} ]}^{- 1} \cdot {[ \begin{matrix}X \\ Y \\ Z\end{matrix} ]}_{white} & ( 8 )\end{matrix}$$

It is possible to scale the luminance matrix (L) in Eq. 5 by a constant value and not change the chromaticities of the mixture colors. This relationship is shown in Eqs. 9-13 (e.g., where the L matrix was normalized by the luminance of the green channel). In these cases the overall luminance of the display devices can be scaled to an arbitrary level and not effect the relative colorimetric-mixing characteristics of the device. In a color management system it is, often times, not important to know the absolute luminance of a display device (e.g., ones where it is not possible or not desirable to match the absolute luminances between the original and the reproductions).

$$\begin{matrix}{M}_{relative} = C \cdot {L}_{relative} = [ \begin{matrix}\frac{{x}_{red}}{{y}_{red}} & \frac{{x}_{green}}{{y}_{green}} & \frac{{x}_{blue}}{{y}_{blue}} \\ \frac{{z}_{red}}{{y}_{red}} & \frac{{z}_{green}}{{y}_{blue}} & \frac{{z}_{blue}}{{y}_{blue}}\end{matrix} ] \cdot [ \begin{matrix}{Y}_{red} & 0 & 0 \\ 0 & {Y}_{green} & 0 \\ 0 & 0 & {Y}_{blue}\end{matrix} ] \cdot \frac{1}{{Y}_{green}} & ( 9 ) \\ {M}_{relative} = C \cdot {L}_{relative} = [ \begin{matrix}\frac{{x}_{red}}{{y}_{red}} & \frac{{x}_{green}}{{y}_{green}} & \frac{{x}_{blue}}{{y}_{blue}} \\ \frac{{z}_{red}}{{y}_{red}} & \frac{{z}_{green}}{{y}_{green}} & \frac{{z}_{blue}}{{y}_{blue}}\end{matrix} ] \cdot [ \begin{matrix}\frac{{Y}_{red}}{{Y}_{green}} & 0 & 0 \\ 0 & 1 & 0 \\ 0 & 0 & \frac{{Y}_{blue}}{{Y}_{green}}\end{matrix} ] & ( 10 )\end{matrix}$$

It follows that if one color is a scaled version of another color, their chromaticities are equal. Therefore, if XYZ₁=αXYZ₂ then:

$$\begin{matrix}{x}_{1} = \frac{{X}_{1}}{{X}_{1} + {Y}_{1} + {Z}_{1}} , {y}_{1} = \frac{{Y}_{1}}{{X}_{1} + {Y}_{1} + {Z}_{1}} , \text{and} {z}_{1} = \frac{{Z}_{1}}{{X}_{1} + {Y}_{1} + {Z}_{1}} \\ \text{and} & ( 11 ) \\ {x}_{2} = \frac{ {αX}_{1}}{α ( {X}_{1} + {Y}_{1} + {Z}_{1} )} , {y}_{2} = \frac{ {αY}_{1}}{α ( {X}_{1} + {Y}_{1} + {Z}_{1} )} , \text{and} {z}_{2} = \frac{α {Z}_{1}}{α ( {X}_{1} + {Y}_{1} + {Z}_{1} )} & ( 12 )\end{matrix}$$

Thus, for the case of one color being a scaled version of another color:

x₁=x₂, y₁=y₂, and z₁=z₂. (13)

As such, a model of the display's relative calorimetric mixing characteristics is obtained by solving for the luminance ratios shown in Eq. 10. The formalism developed in Eq. 10 showed the relative luminance matrix (Lᵣₑₗₐₜᵢᵥₑ) normalized by the luminance of the green channel. The green channel was picked for illustration purposes only. (In practice any display channel could have been used for this normalization.)

First Embodiment: Visual Estimation of Display Channel Luminance Ratios wherein the heterochromatic flicker photometry includes a reference patch having a predefined color and test stimulus having adjustable pure channel colors and wherein the flicker is minimized by adjusting each pure channel color to have the same luminance as the reference color.

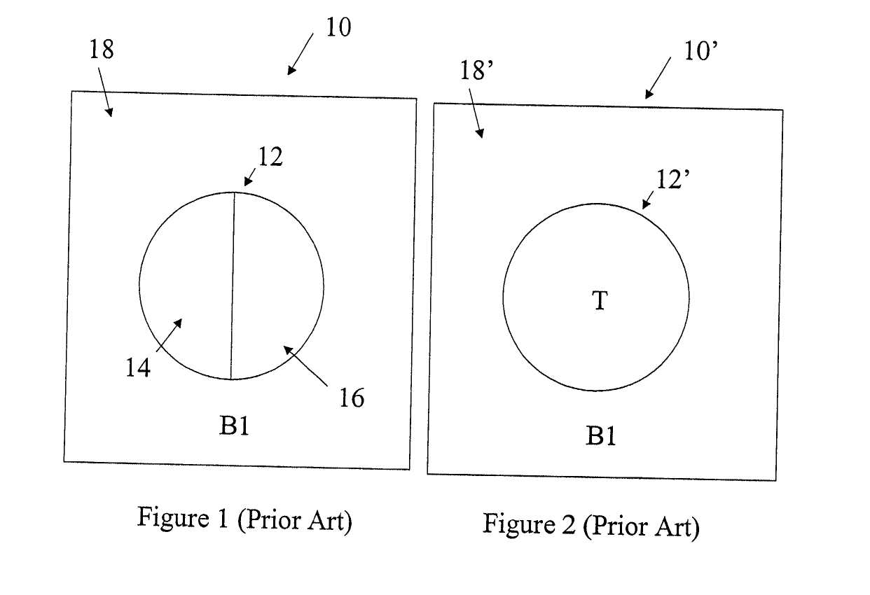

Heterochromatic brightness matching is a well-established psychophysical technique for measuring visual processes. Typically two psychophysical techniques are utilized in a heterochromatic brightness matching technique. Referring to FIG. 1, the first technique utilizes a display patch 10 that includes bipartite field 12 in which one half 14 is a reference stimulus (S1) and the other half 16 is the test stimulus (S2) against a background 18. Often times, the reference stimulus (S1) is an achromatic color and the test stimulus (S2) is a chromatic color. The viewer's task is to adjust the intensity of the test stimulus (S2) until it matches the brightness of the reference stimulus (S 1). This judgement is often made easier by having the viewer adjust the test stimulus until the edge (L1) that is formed between the two fields is the least distinct. However, in general, this process is rarely used because it is difficult to visually discount the differences in hue and chroma between the two fields.

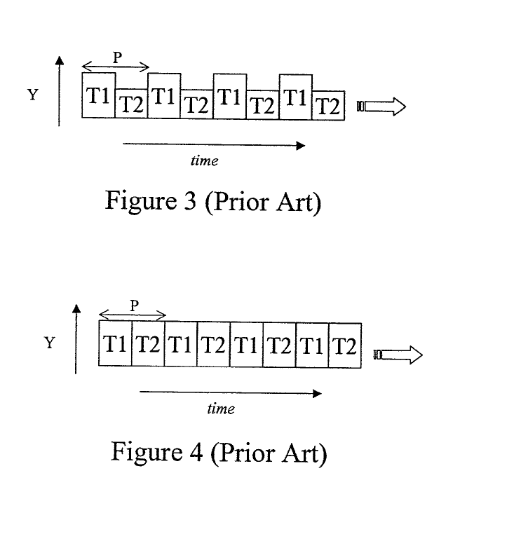

Referring to FIG. 2, a second process for heterochromatic brightness matching uses a flicker process whereby spatially coincident stimuli are alternately presented at some predefined temporal rate in a patch 10′ having a stimulus area 12′ and a background 18′. Referring to FIG. 3, one of the stimuli is a reference field with a predefined luminance level T1. This stimulus can either be achromatic or chromatic. The other stimulus T2 is generally chromatic and adjustable in luminance. The viewer adjusts the luminance of this test stimulus T2 until the perceived flicker is minimized or eliminated. As shown in FIG. 4, the flicker is minimized or eliminated when the luminance of T1 equals the luminance of T2.

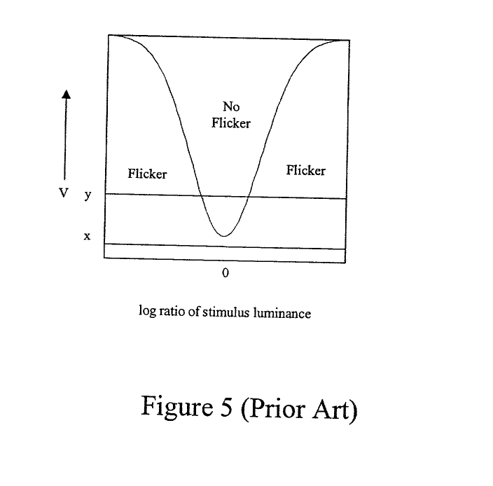

Referring to FIG. 5, it is known that the ability for the viewer to completely eliminate the appearance of flicker depends on the luminance and the chromatic differences between the reference stimulus T1 and the test stimulus T2. For a given rate of flicker V, the viewer will only be able to eliminate flicker if the luminance ratio of the two stimuli is within a given range. This range is a function of flicker rate and color difference between the stimuli. If the flicker rate V is low and the color difference between the patches is large, then the viewer may never be able to completely eliminate the appearance of flicker even if the luminances of the stimuli are equal (e.g., line x in FIG. 5). In this case, the experimenter can increase the flicker rate V so that stimulus fusion is possible with the given color or instruct the viewer to adjust the intensity to the point of minimum flicker. If the flicker rate V is too high, then there will be a range of stimulus ratios where the viewer can eliminate flicker, (e.g., line y in FIG. 5). In this case, the experimenter can either reduce the flicker rate or instruct the viewer to bisect the stimulus range of temporal fusion to estimate the luminance match.

For the case of determining the ratios of the display luminances, consider the following minimum flicker experiment. The reference stimulus T1 is some fraction of the luminance of the sum of the luminances of the display channels. If the luminance of the reference stimulus T1 is less than or equal to that of the channel with the smallest individual luminance, then a luminance match is possible using any of the individual channels. Given these conditions, consider the experiment where the test stimulus T2 is one of the display's individual channels (i.e., pure red, green, or blue). The two stimuli are presented at some frequency V slow enough that the stimuli don't temporally fuse for a large ratio of stimuli luminances, but high enough that the flicker is minimal or null when the physical luminances of the stimuli are matched.

The viewer's task is to adjust the intensity of the individual channel T2 to the point of minimum or null flicker. This process is repeated for all display channels individually. This experiment results in a set of data that represents the percentage of each display channel that is required to match a given stimulus. For example, consider the case of a three-channel display. Suppose, for channel 1, α percent of that channel's maximum luminance was required to minimize the flicker. Additionally, for channels 2 and 3, β and κ percent of their respective maximum luminances were needed to minimize the flicker. For the case where α <β<κ, it is possible to say that the Y₁>Y₂>Y₃ where Y₁, Y₂, and Y₃ are the maximum luminances of the three channels. The inverses of ratios of the channel percentages are equivalent to the ratios given in Eq. 10. This relationship is formalized in Eqs. 14-21.

Consider a white point whose XYZ values equal the sum of the XYZ values of the display channels. Then,

Y_{white}=Y_{red}+Y_{green}+Y_{blue}. (14)

Consider a neutral color that has a luminance equal to some fraction of the Y_{white}. Then,

Yₙ=a·Y_{white}. (15)

Suppose that a is small such that

$${Y}_{n} \leq min [ \begin{matrix}{Y}_{red} \\ {Y}_{green} \\ {Y}_{blue}\end{matrix} ] . \qquad ( 16 )$$

For the red channel suppose that the flicker is minimized or null when α percent of the red channel luminance was used to match the luminance of Yₙ. Then,

Yₙ=α·Y_{red} (17)

(Note: For a CRT display, α is generally nonlinearly related to the input digital counts driving the display. Thus,

α=f(α′) (18)

where the function described by f can be either linear or nonlinear and α′ is the digital count of the signal driving the display.)

It follows from Eq. 17 that,

$$α = \frac{{Y}_{n}}{{Y}_{red}} . \qquad ( 19 )$$

Similar expressions can be written for the green and blue channels such that:

$$\begin{matrix}β = \frac{{Y}_{n}}{{Y}_{green}} \\ \text{and} & ( 20 ) \\ κ = \frac{{Y}_{n}}{{Y}_{blue}} . & ( 21 )\end{matrix}$$

Recall that the goal of this experiment was to determine the ratios of Y_{red}/Y_{green} and Y_{blue}/Y_{green}. Therefore, using the relationships formed in Eqs. 19-21, it follows that estimates of these ratios are obtained by

$$\begin{matrix}\frac{β}{α} = \frac{\frac{{Y}_{n}}{{Y}_{green}}}{\frac{{Y}_{n}}{{Y}_{red}}} = \frac{{Y}_{red}}{{Y}_{green}} \\ \text{and} & ( 22 ) \\ \frac{κ}{α} = \frac{\frac{{Y}_{n}}{{Y}_{green}}}{\frac{{Y}_{n}}{{Y}_{blue}}} = \frac{{Y}_{blue}}{{Y}_{green}} . & ( 23 )\end{matrix}$$

The only assumption made in this process was that the conversion process from device digital code values (f) to channel luminance scalars is known. Visual characterization processes given by Daly et al. (supra) have formalized this process. Given these luminance ratios and an assumed C matrix as shown in Eq. 10, it is possible to specify a relative colorimetric mixing matrix for the display device. For practical purposes, the C matrix used in Eq. 10 can be assumed based on some generic chromaticity model for a given display type or can be entered by the viewer. This type of assumption is consistent with that presented by Daly et al. (supra).

First Embodiment (continued): Determining Channel Luminance Ratios and Display's Relative Colorimetric Mixing Matrix from Viewer Adjustments

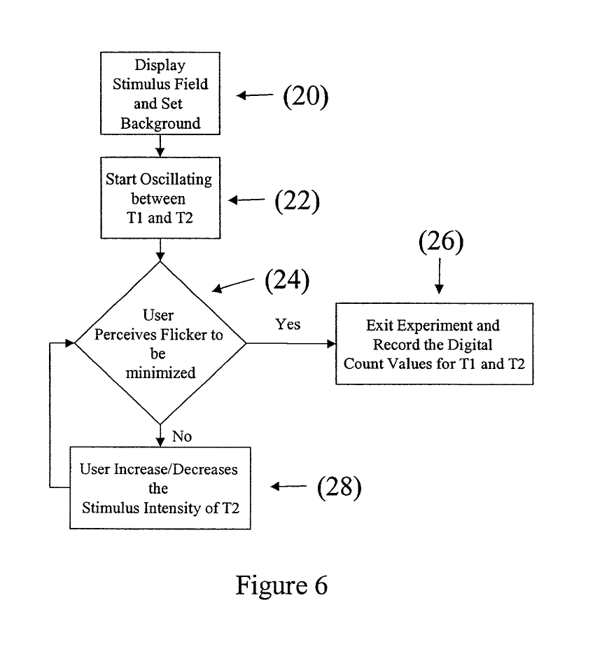

An example heterochromatic flicker photometry experiment, designed to collect the data necessary to solve for the channel luminance ratios using the First Embodiment, is shown in FIG. 6. The experiment begins by displaying (20) a stimulus field T (12′), as shown in FIG. 2, and setting the background B1 (18′) to initial values. The stimulus field T is then oscillated (22) between stimuli T1 and T2, as shown in FIG. 3, at a flicker rate V (e.g., V=1/P). The viewer then adjusts a control (through an interface to a computer that is used to generate the display, such as by the keyboard or the mouse) to increase or decrease the intensity of stimulus T2. If the viewer perceives the flicker between T1 and T2 to be minimized (24), they exit the experiment (26) and the host computer records the digital count values for T1 and T2. If the viewer decides that the flicker between T1 and T2 is not minimized, the viewer continue to adjust T2 (28) and make judgements on the perceived flicker until the flicker is minimized. At that point, the host computer records the digital counts of stimuli T1 and T2. This experiment is performed three times: once each for the red, green, and blue channels.

The data from these experiments are a set of digital count triplets: one for each of the display channels. These digital count triplets represent the T2 values that minimized the flicker between the reference stimulus T1 and the pure channel color. These digital count triplets are converted into channel luminance ratios using the following procedure. First the stimulus digital count values ([RGB]ₚᵤᵣₑ) are converted to calorimetric channel scalars ([rgb]ₚᵤᵣₑ) using a predetermined function (f) as described by Eq. 18 giving:

rₚᵤᵣₑ=f(Rₚᵤᵣₑ), gₚᵤᵣₑ=f(Gₚᵤᵣₑ), and bₚᵤᵣₑ=f(Bₚᵤᵣₑ) (24)

According to the relationships given in Eqs. 22 and 23, the pure channel luminance scalars are converted into display channel luminance ratios:

$$\begin{matrix}\frac{{Y}_{red}}{{Y}_{green}} = \frac{{g}_{pure}}{{r}_{pure}} \\ \text{and} & ( 25 ) \\ \frac{{Y}_{blue}}{{Y}_{green}} = \frac{{g}_{pure}}{{b}_{pure}} & ( 26 )\end{matrix}$$

The display's relative colorimetric mixing matrix (M) is then obtained using the relationship given in Eq. 10.

Second Embodiment: Addition of a base stimulus (Tb) to the test (T2) stimulus wherein the heterochromatic flicker photometry includes a reference patch having a predefined color and test stimuli having a constant predetermined base and adjustable pure channel colors and wherein the flicker is minimized by adjusting each pure channel color to have the same luminance as the reference color

In the First Embodiment, a process was generalized whereby the red, green, and blue channel luminance ratios were estimated by minimizing the flicker between a neutral patch and a pure channel patch (i.e., either red, green, or blue). The pure channel approach works well for the situation where relatively high flicker rates are possible. Since the chromatic difference between the reference stimulus T1 and the test stimulus T2 is large for the single channel approach described above, the flicker rate needs to be high in order to eliminate the flicker between the two stimuli even when a luminance match is achieved. In order to help reduce this effect a second stimulus presentation is presented.

In this case, the reference stimulus T1 is the same as given in Eq. 15. Now, instead of being a pure channel, the test stimulus T2 is composed of two parts. The first part is a base stimulus (Tbase) that is lower in luminance than the reference stimulus T1. Added to this base stimulus is a pure channel stimulus (Tpure) that contributes the added luminance necessary to either minimize or eliminate the flicker between the reference patch T1 and the test patch (T2=Tbase+Tpure). By introducing the base stimulus luminance (Tbase), the initial luminance difference between the reference stimulus T1 and the test stimulus T2 is decreased when compared to the pure channel approach. Thus, the amount of extra pure channel luminance (Tpure) needed to create a luminance match is less. By reducing the amount of pure channel luminance contribution (Tpure) to the match, the chromatic differences between the reference T1 and the test T2 stimuli is reduced, making the psychophysical task easier.

The mathematics of this process is very similar to those given in the First Embodiment and are formalized in Eqs. 27-36. Consider the reference patch T1 whose chromaticities are the same as the white point and whose luminance is some fraction (b) of the white, Eq. 27. Also, consider a base stimulus (Tbase) whose luminance is a different, but smaller, fraction (c) of the white (i.e., b>c), Eq. 28. Thus,

Yₙ=b·Y_{white}=b·Y_{red}+b·Y_{green}+b·Y_{blue} (27)

Y_{base}=c·Y_{white}=c·Y_{red}+c·Y_{green}+c·Y_{blue} (28)

where b and c are selected such that,

$${Y}_{n} - {Y}_{base} \leq min [ \begin{matrix}{Y}_{red} - c \cdot {Y}_{red} \\ {Y}_{green} - c \cdot {Y}_{green} \\ {Y}_{blue} - c \cdot {Y}_{blue}\end{matrix} ] . \qquad ( 29 )$$

The constraint imposed by Eq. 29 insures that there is enough pure channel luminance (Tpure) available to overcome the luminance difference between the reference (T1) and the base stimuli (Tbase). A luminance match between the reference patch T1 and the test patch T2 is achieved when:

Yₙ=Yₜₑₛₜ=Y_{base}+Yₚᵤᵣₑ (30)

where Yₚᵤᵣₑ is the added red, green, or blue single channel luminance need to make up the luminance difference between the reference (Yₙ) and the base (Y_{base}) stimuli luminances. Therefore, for the case of using ε_{red} of the red channel to make up the luminance difference,

b·Y_{white}=c·Y_{white}+ε_{red}·Y_{red,} (31)

Solving for ε_{red} yields,

$${ϵ}_{red} = \frac{{Y}_{n} - {Y}_{base}}{{Y}_{red}} \qquad ( 32 )$$

Similar relationships can be written for the green and blue channels:

$$\begin{matrix}{ϵ}_{green} = \frac{{Y}_{n} - {Y}_{base}}{{Y}_{green}} \\ \text{and} & ( 33 ) \\ {ϵ}_{blue} = \frac{{Y}_{n} - {Y}_{base}}{{Y}_{blue}} . & ( 34 )\end{matrix}$$

Recall that the underlying task was to determine the ratios of the channel luminances (e.g., Y_{red}/Y_{green} and Y_{blue}/Y_{green}). Therefore, using the relationships given in Eqs. 32-34:

$$\begin{matrix}\frac{{ϵ}_{green}}{{ϵ}_{red}} = \frac{\frac{{Y}_{n} - {Y}_{base}}{{Y}_{green}}}{\frac{{Y}_{n} - {Y}_{base}}{{Y}_{red}}} = \frac{{Y}_{red}}{{Y}_{green}} \\ \text{and} & ( 35 ) \\ \frac{{ϵ}_{green}}{{ϵ}_{blue}} = \frac{\frac{{Y}_{n} - {Y}_{base}}{{Y}_{green}}}{\frac{{Y}_{n} - {Y}_{base}}{{Y}_{blue}}} = \frac{{Y}_{blue}}{{Y}_{green}} . & ( 36 )\end{matrix}$$

Second Embodiment (Continued): Determining Channel Ratios from Viewer Adjustments

Using the process given in the Second Embodiment requires that the parameters ε_{red}, ε_{green}, and ε_{blue}, from Eqs. 32-34, be determined experimentally. The psychophysical task can either be minimum flicker or heterochromatic brightness matching of a bipartite field. For illustration purposes, consider the minimum flicker experiment (FIG. 6) where the display's digital code values for the reference patch T1 are given by:

$${T}_{1} = {[ \begin{matrix}R \\ G \\ B\end{matrix} ]}_{ref} \qquad ( 37 )$$

where R_{ref}=G_{ref}=B_{ref}. Also, consider a test stimulus (T2) that has as a base component (Tbase) with a digital count value of

$${T}_{base} = {[ \begin{matrix}R \\ G \\ B\end{matrix} ]}_{base} \qquad ( 38 )$$

where R_{base}=G_{base}=B_{base}<R_{ref} and a variable component Tpure. The component (Tpure) is added to a selected channel of Tbase. The digital counts associated with the test stimulus composed of an adjustable red component of T2 are given by:

$${T}_{{2}_{Case1}} = {[ \begin{matrix}R \\ G \\ B\end{matrix} ]}_{testR} = {[ \begin{matrix}R \\ G \\ B\end{matrix} ]}_{base} + {[ \begin{matrix}R \\ 0 \\ 0\end{matrix} ]}_{pure} = [ \begin{matrix}{R}_{base} + {R}_{pure} \\ {G}_{base} \\ {B}_{base}\end{matrix} ] \qquad ( 39 )$$

For the cases where the pure green or blue channels are used to minimize the flicker, the test stimulus (T2) takes on the forms:

$$\begin{matrix}{T}_{{2}_{Case2}} = {[ \begin{matrix}R \\ G \\ B\end{matrix} ]}_{testG} = {[ \begin{matrix}R \\ G \\ B\end{matrix} ]}_{base} + {[ \begin{matrix}0 \\ G \\ 0\end{matrix} ]}_{pure} = [ \begin{matrix}{R}_{base} \\ {G}_{base} + {G}_{pure} \\ {B}_{base}\end{matrix} ] \\ \text{and} & ( 40 ) \\ {T}_{{2}_{Case3}} = {[ \begin{matrix}R \\ G \\ B\end{matrix} ]}_{testB} = {[ \begin{matrix}R \\ G \\ B\end{matrix} ]}_{base} + {[ \begin{matrix}0 \\ 0 \\ B\end{matrix} ]}_{pure} = [ \begin{matrix}{R}_{base} \\ {G}_{base} \\ {B}_{base} + {B}_{pure}\end{matrix} ] & ( 41 )\end{matrix}$$

Therefore, the data that gets returned from the experiment are the test stimulus code values (T2) for the red, green, and blue cases. These data are used to predict the channel luminance ratios using the following analysis.

The data are converted to relative colorimetric channel scalars using the predetermined nonlinear equations for this process (e.g., (f) from Eq. 18). The channel scalars (denoted by the lower case r,g,b) for the reference and the base stimuli are given by:

$$\begin{matrix}{[ \begin{matrix}r \\ g \\ b\end{matrix} ]}_{ref} = f ( {[ \begin{matrix}R \\ G \\ B\end{matrix} ]}_{ref} ) \\ \text{and} & ( 42 ) \\ {[ \begin{matrix}r \\ g \\ b\end{matrix} ]}_{base} = f ( {[ \begin{matrix}R \\ G \\ B\end{matrix} ]}_{base} ) & ( 43 )\end{matrix}$$

where the function (f) has been determined using some visual estimation process, such as that given by Daly et al. (supra). Suppose that the flicker between the reference (T1) and the test (T2) stimuli was minimized by adjusting the red channel of the test stimulus until the digital code values were:

$${[ \begin{matrix}R \\ G \\ B\end{matrix} ]}_{testR} = [ \begin{matrix}{R}_{test} \\ {G}_{base} \\ {B}_{base}\end{matrix} ] . \qquad ( 44 )$$

The channel scalars for this stimulus are given by:

$${[ \begin{matrix}r \\ g \\ b\end{matrix} ]}_{testR} = f ( {[ \begin{matrix}R \\ G \\ B\end{matrix} ]}_{testR} ) = [ \begin{matrix}{r}_{test} \\ {g}_{base} \\ {b}_{base}\end{matrix} ] = [ \begin{matrix}{r}_{base} + {r}_{pure} \\ {g}_{base} \\ {b}_{base}\end{matrix} ] \qquad ( 45 )$$

where rₚᵤᵣₑ is the extra red channel luminance needed to match the reference (T1) patch or minimize the flicker. The amount of the pure channel red luminance needed to make up the difference between the base color and the reference color is given by:

$${[ \begin{matrix}r \\ g \\ b\end{matrix} ]}_{pureR} = {[ \begin{matrix}r \\ g \\ b\end{matrix} ]}_{testR} - {[ \begin{matrix}r \\ g \\ b\end{matrix} ]}_{base} = [ \begin{matrix}{r}_{base} + {r}_{pure} \\ {g}_{base} \\ {b}_{base}\end{matrix} ] - {[ \begin{matrix}r \\ g \\ b\end{matrix} ]}_{base} = [ \begin{matrix}{r}_{pure} \\ 0 \\ 0\end{matrix} ] \qquad ( 46 )$$

When the experiment is repeated for the cases where the pure green and blue channels are used to make up the luminance difference between the base color and the reference color then the following relationships can be determined:

$$\begin{matrix}{[ \begin{matrix}r \\ g \\ b\end{matrix} ]}_{pureG} = {[ \begin{matrix}r \\ g \\ b\end{matrix} ]}_{testG} - {[ \begin{matrix}r \\ g \\ b\end{matrix} ]}_{base} = [ \begin{matrix}{r}_{base} \\ {g}_{base} + {g}_{pure} \\ {g}_{base}\end{matrix} ] - {[ \begin{matrix}r \\ g \\ b\end{matrix} ]}_{base} = [ \begin{matrix}0 \\ {g}_{pure} \\ 0\end{matrix} ] \\ \text{and} & ( 47 ) \\ {[ \begin{matrix}r \\ g \\ b\end{matrix} ]}_{pureB} = {[ \begin{matrix}r \\ g \\ b\end{matrix} ]}_{testB} - {[ \begin{matrix}r \\ g \\ b\end{matrix} ]}_{base} = [ \begin{matrix}{r}_{base} \\ {g}_{base} \\ {b}_{base} + {b}_{pure}\end{matrix} ] - {[ \begin{matrix}r \\ g \\ b\end{matrix} ]}_{base} = [ \begin{matrix}0 \\ 0 \\ {b}_{pure}\end{matrix} ] . & ( 48 )\end{matrix}$$

The ratios of the Y_{red}/Y_{green} and Y_{blue}/Y_{green} are calculated using the relationships given in Eqs. 25 and 26 by:

$$\begin{matrix}\frac{{Y}_{red}}{{Y}_{green}} = \frac{{g}_{pure}}{{r}_{pure}} \\ \text{and} & ( 49 ) \\ \frac{{Y}_{blue}}{{Y}_{green}} = \frac{{g}_{pure}}{{b}_{pure}} . & ( 50 )\end{matrix}$$

As was the case in the First Embodiment, these ratios are used in combination with a C matrix to generate a relative colorimetric mixing matrix for the display (Eq. 10).

Third Embodiment: Using Stimuli other than Red, Green, and Blue: General Case wherein the heterochromatic flicker photometry includes a reference patch having a predefined color and test stimuli having a constant predetermined base and adjustable mixed channel colors and wherein the flicker is minimized by adjusting each mixed channel color to have the same luminance as the reference color.

In this embodiment of the invention, a general case is disclosed that uses stimuli other than pure red, green, and blue. In this case, any set of three colors, with a common base, can be flickered against any other color. Therefore, in this embodiment, it is convenient to define the relative calorimetric channel scalars for the reference stimulus T1 as

$${T}_{1} = {[ \begin{matrix}r \\ g \\ b\end{matrix} ]}_{ref} \qquad ( 51 )$$

and a test stimulus (T2) with a base stimulus (Tbase) as

$${T}_{2} = {T}_{base} + {T}_{s} = {[ \begin{matrix}r \\ g \\ b\end{matrix} ]}_{base} + {[ \begin{matrix}r \\ g \\ b\end{matrix} ]}_{s} \qquad ( 52 )$$

where the luminance of T1 (given by Y1) is greater that the luminance of Tbase (given by Ybase). Thus, consider the experiment where T1 is initially flickered against Tbase at a rate defined by P, such that flicker is perceived by the viewer. In this experiment, consider the case where the flicker is minimized, in three separate trials, with three different stimuli (Ts) being added to Tbase. These stimuli are represented by:

$${T}_{{s}_{1}} = {[ \begin{matrix}r \\ g \\ b\end{matrix} ]}_{1} , {T}_{{s}_{2}} = {[ \begin{matrix}r \\ g \\ b\end{matrix} ]}_{2} , \text{and} {T}_{{s}_{3}} = {[ \begin{matrix}r \\ g \\ b\end{matrix} ]}_{3} \qquad ( 53 )$$

where the subscripts 1, 2 and 3 represent the calorimetric channel scalars of the stimuli added to (Tbase) for the three trials. Since the flicker was minimized in each of these trials, the luminance of T1 (Y1) was equal to the luminance T2 (Y2 =Ybase+Y(Ts1)=Ybase+Y(Ts2)=Ybase+Y(Ts3)). Based on this relationship it is possible to make the following generalization:

$$[ \begin{matrix}{Y}_{1} \\ {Y}_{1} \\ {Y}_{1}\end{matrix} ] = [ \begin{matrix}{Y}_{base} \\ {Y}_{base} \\ {Y}_{base}\end{matrix} ] + [ \begin{matrix}{r}_{1} & {g}_{1} & {b}_{1} \\ {r}_{2} & {g}_{2} & {b}_{2} \\ {r}_{3} & {g}_{3} & {b}_{3}\end{matrix} ] \cdot [ \begin{matrix}{Y}_{red} \\ {Y}_{green} \\ {Y}_{blue}\end{matrix} ] \qquad ( 54 )$$

where the rows of the matrix are the calorimetric channel scalars for three flicker minimization trials respectively. Notice that, in each of the trials, the values for Y1 and Ybase are constant. Also, recall that the goals of these experiments are to solve for the ratios of Yred/Ygreen and Yblue/Ygreen, not the absolute values of the channel luminances, Therefore, Equation 54 can be rewritten as:

$$[ \begin{matrix}{Y}_{1} \\ {Y}_{1} \\ {Y}_{1}\end{matrix} ] - [ \begin{matrix}{Y}_{base} \\ {Y}_{base} \\ {Y}_{base}\end{matrix} ] = Δ 1 \cdot [ \begin{matrix}1 \\ 1 \\ 1\end{matrix} ] = [ \begin{matrix}{r}_{1} & {g}_{1} & {b}_{1} \\ {r}_{2} & {g}_{2} & {b}_{2} \\ {r}_{3} & {g}_{3} & {b}_{3}\end{matrix} ] \cdot [ \begin{matrix}{Y}_{red} \\ {Y}_{green} \\ {Y}_{blue}\end{matrix} ] \qquad ( 55 )$$

where (Δ1) is a constant that is equal to the luminance difference between the base (Tbase) and the reference stimuli T1. Solving for the display channel luminances yields:

$$[ \begin{matrix}{Y}_{red} \\ {Y}_{green} \\ {Y}_{blue}\end{matrix} ] = {[ \begin{matrix}{r}_{1} & {g}_{1} & {b}_{1} \\ {r}_{2} & {g}_{2} & {b}_{2} \\ {r}_{3} & {g}_{3} & {b}_{3}\end{matrix} ]}^{- 1} \cdot Δ 1 \cdot [ \begin{matrix}1 \\ 1 \\ 1\end{matrix} ] \qquad ( 56 )$$

Dropping the absolute luminance term (Δ1) yields relative channel luminance factors given by:

$$[ \begin{matrix}{\hat{Y}}_{red} \\ {\hat{Y}}_{green} \\ {\hat{Y}}_{blue}\end{matrix} ] = {[ \begin{matrix}{r}_{1} & {g}_{1} & {b}_{1} \\ {r}_{2} & {g}_{2} & {b}_{2} \\ {r}_{3} & {g}_{3} & {b}_{3}\end{matrix} ]}^{- 1} \cdot [ \begin{matrix}1 \\ 1 \\ 1\end{matrix} ] \qquad ( 57 )$$

The display's channel-luminance ratios are calculated using these relative luminance factors using:

$$\begin{matrix}\frac{{Y}_{red}}{{Y}_{green}} = \frac{{\hat{Y}}_{red}}{{\hat{Y}}_{green}} \\ \text{and} & ( 58 ) \\ \frac{{Y}_{blue}}{{Y}_{green}} = \frac{{\hat{Y}}_{blue}}{{\hat{Y}}_{green}} & ( 59 )\end{matrix}$$

Third Embodiment (Continued): Example Visual Experiment

The same visual experiment used in the Second Embodiment can be used to collect the data necessary to calculate the display's channel-luminance ratios. The only difference in this case is that the stimuli used to overcome the luminance difference between T1 and Tbase are not pure channel signals. They can have any RGB digital counts that produce the correct luminance (i.e., the luminance difference between T1 and Tbase). The data from this experiment consist of RGBref (Eq. 42), RGBbase (Eq. 43), and the RGB values for three T2 values (shown in Eqs. 60-62) that minimized the flicker between T1 and T2.

$$\begin{matrix}{T}_{{2}_{Case1}} = f ( {[ \begin{matrix}R \\ G \\ B\end{matrix} ]}_{Case1} ) = {[ \begin{matrix}r \\ g \\ b\end{matrix} ]}_{Case1} & ( 60 ) \\ {T}_{{2}_{Case2}} = f ( {[ \begin{matrix}R \\ G \\ B\end{matrix} ]}_{Case2} ) = {[ \begin{matrix}r \\ g \\ b\end{matrix} ]}_{Case2} & ( 61 ) \\ {T}_{{2}_{Case3}} = f ( {[ \begin{matrix}R \\ G \\ B\end{matrix} ]}_{Case3} ) = {[ \begin{matrix}r \\ g \\ b\end{matrix} ]}_{Case3} & ( 62 )\end{matrix}$$

The test stimuli (T2) for the three cases are decomposed into base (Tbase) and added components (Ts) by subtracting off the calorimetric channel scalars of the base from the test stimuli, giving:

$$\begin{matrix}{T}_{{S}_{Case1}} = {[ \begin{matrix}r \\ g \\ b\end{matrix} ]}_{Case1} - {[ \begin{matrix}r \\ g \\ b\end{matrix} ]}_{base} = [ \begin{matrix}{r}_{1} \\ {g}_{1} \\ {b}_{1}\end{matrix} ] & ( 63 ) \\ {T}_{{S}_{Case2}} = {[ \begin{matrix}r \\ g \\ b\end{matrix} ]}_{Case2} - {[ \begin{matrix}r \\ g \\ b\end{matrix} ]}_{base} = [ \begin{matrix}{r}_{2} \\ {g}_{2} \\ {b}_{2}\end{matrix} ] & ( 64 ) \\ {T}_{{S}_{Case3}} = {[ \begin{matrix}r \\ g \\ b\end{matrix} ]}_{Case3} - {[ \begin{matrix}r \\ g \\ b\end{matrix} ]}_{base} = [ \begin{matrix}{r}_{3} \\ {g}_{3} \\ {b}_{3}\end{matrix} ] & ( 65 )\end{matrix}$$

The scalars given in Eqs. 63-65 are used to create the set of linear equations as shown in Eq. 57, making it possible to solve for the relative channel-luminance ratios:

$$\frac{{\hat{Y}}_{red}}{{\hat{Y}}_{green}} \text{and} \frac{{\hat{Y}}_{blue}}{{\hat{Y}}_{green}} . \qquad ( 66 )$$

These relative channel-luminance ratios are then combined with a predefined C matrix, as given in Eq. 10, to form a relative colorimetric mixing matrix (M) for the display.

Fourth Embodiment: Directly solve for the channel ratios by flickering against a pure channel (e.g., green) wherein the heterochromatic flicker photometry includes a reference patch having a constant pure channel color and test stimulus having a constant predetermined base and adjustable pure channel colors and wherein the flicker is minimized by adjusting the other pure channel colors to have the same luminance as the reference pure channel color

In the first three embodiments, the three visual trials were performed to generate data necessary to solve for the channel-luminance ratios of the display. These channel-luminance ratios were used to develop a relative colorimetric mixing matrix for the display. In this embodiment of the current invention, a process is generalized that can be used to solve for the channel-luminance ratios using two trials. In this case, a test stimulus (T2) having a given pure component (e.g., red) is flickered, for example, against a reference stimulus (T1) having a given pure component (e.g., green).

$$\begin{matrix}{T}_{1} = {T}_{base} + {T}_{{pure}_{green}} = {[ \begin{matrix}R \\ G \\ B\end{matrix} ]}_{base} + {[ \begin{matrix}0 \\ G \\ 0\end{matrix} ]}_{pure} & ( 67 ) \\ {T}_{{2}_{red}} = {T}_{base} + {T}_{{pure}_{red}} = {[ \begin{matrix}R \\ G \\ B\end{matrix} ]}_{base} + {[ \begin{matrix}R \\ 0 \\ 0\end{matrix} ]}_{pure} & ( 68 )\end{matrix}$$

Both T1 and T2_{red} have the same base stimulus. The reference stimulus (T1) has a constant amount of green stimulus. The test stimulus (T2) has an adjustable red component. The viewer adjusts the intensity of this component until the flicker is minimized.

In a second trial, the reference stimulus (T1) is flickered against a second test stimulus (T2_{blue}) that has an adjustable blue component that is used to minimize the flicker given by:

$${T}_{{2}_{blue}} = {T}_{base} + {T}_{{pure}_{blue}} = {[ \begin{matrix}R \\ G \\ B\end{matrix} ]}_{base} + {[ \begin{matrix}0 \\ 0 \\ B\end{matrix} ]}_{pure} \qquad ( 69 )$$

The results of this experiment are a set of digital counts that represent the amounts of pure red and blue stimuli needed to balance the luminance of a given green stimulus. These calorimetric channel scalar amounts are determined by converting T1, T2red, and T2blue into calorimetric channel scalars using a predefined function (f), defined in Eq. 18, giving:

$$\begin{matrix}{[ \begin{matrix}0 \\ g \\ 0\end{matrix} ]}_{pure} = f ( {T}_{1} ) - f ( {[ \begin{matrix}R \\ G \\ B\end{matrix} ]}_{base} ) = [ \begin{matrix}{r}_{base} \\ {g}_{base} + {g}_{pure} \\ {b}_{base}\end{matrix} ] - {[ \begin{matrix}r \\ g \\ b\end{matrix} ]}_{base} & ( 70 ) \\ {[ \begin{matrix}r \\ 0 \\ 0\end{matrix} ]}_{pure} = f ( {T}_{{2}_{red}} ) - f ( {[ \begin{matrix}R \\ G \\ B\end{matrix} ]}_{base} ) = [ \begin{matrix}{r}_{base} + {r}_{pure} \\ {g}_{base} \\ {b}_{base}\end{matrix} ] - {[ \begin{matrix}r \\ g \\ b\end{matrix} ]}_{base} & ( 71 ) \\ {[ \begin{matrix}0 \\ 0 \\ b\end{matrix} ]}_{pure} = f ( {T}_{{2}_{blue}} ) - f ( {[ \begin{matrix}R \\ G \\ B\end{matrix} ]}_{base} ) = [ \begin{matrix}{r}_{base} \\ {g}_{base} \\ {b}_{base} + {b}_{pure}\end{matrix} ] - {[ \begin{matrix}r \\ g \\ b\end{matrix} ]}_{base} & ( 72 )\end{matrix}$$

Thus, the proportion of the pure green channel scalar to pure red channel scalar gives the Yred/Ygreen channel-luminance ratio directly.

$$\frac{{Y}_{red}}{{Y}_{green}} = \frac{{g}_{pure}}{{r}_{pure}} \qquad ( 73 )$$

Likewise, the proportion of the pure green channel scalar to the pure blue channel scalar gives the Yblue/Ygreen channel-luminance ratio directly.

$$\frac{{Y}_{blue}}{{Y}_{green}} = \frac{{g}_{pure}}{{b}_{pure}} \qquad ( 74 )$$

These relative channel-luminance ratios are combined with a predefined C matrix, as shown in Eq. 10, to produce a relative colorimetric mixing matrix for the display. The example cited here used the green channel as the reference stimulus and the blue and the red channels as the test stimuli for the tests. In practice, any of the pure channels could be used as the reference stimulus and the other pure channels could be used as the test stimuli. In such cases, the luminance ratios would be normalized relative to the pure channel used as the reference.

Fourth Embodiment: Example Visual Experiment

An example system designed to collect the data used in the Fourth Embodiment is illustrated in FIG. 6. The invention has been described in detail with particular reference to certain preferred embodiments thereof, but it will be understood that variations and modifications can be effected within the spirit and scope of the invention.

### Parts List

10 display patch

10′ display patch

12 bipartite field

12′ temporally varied field

14 one half of field

16 other half of field

18 background

18′ background

20 display step

22 oscillate field step

24 minimize flicker step

26 exit experiment

28 adjust step

What is claimed is:

1. A method of characterizing a display having a plurality of color channels, comprising the steps of:
a) visually characterizing the gamma of the display; and
b) estimating a calorimetric mixing matrix for the display by determining luminance ratios of the color channels using heterochromatic photometry; and
c) combining these luminance ratios with a chromaticity model for the display channels.

2. The method claimed in claim 1, wherein the heterochromatic photometry is heterochromatic brightness matching photometry.

3. The method claimed in claim 1, wherein the heterochromatic photometry is heterochromatic flicker photometry.

4. The method claimed in claim 3, wherein the heterochromatic flicker photometry includes a reference patch having a predefined color and test stimulus having adjustable pure channel colors and wherein the flicker is minimized by adjusting each pure channel color to have the same luminance as the reference color.

5. The method claimed in claim 3, wherein the heterochromatic flicker photometry includes a reference patch having a predefined color and test stimulus having a constant predetermined base and adjustable pure channel colors and wherein the flicker is minimized by adjusting each pure channel color to have the same luminance as the reference color.

6. The method claimed in claim 3, wherein the heterochromatic flicker photometry includes a reference patch having a predefined color and test stimulus having a constant predetermined base and adjustable mixed channel colors and wherein the flicker is minimized by adjusting each mixed channel color to have the same luminance as the reference color.

7. The method claimed in claim 3, wherein the heterochromatic flicker photometry includes a reference patch having a constant pure channel color and test stimulus having a constant predetermined base and adjustable pure channel colors and wherein the flicker is minimized by adjusting the other pure channel colors to have the same luminance as the reference pure channel color.
